(19) United States
(12) Patent Application Publication
(10) Pub. No.: US 2014/0278218 A1
(43) Pub. Date: Sep. 18, 2014

(54) Capturing and Analyzing Boardsport Maneuver Data

(71) Applicant: DC SHOES, INC., Huntington Beach, CA (US)

(72) Inventor: Wei-En Chang, Huntington Beach, CA (US)

(73) Assignee: DC SHOES, INC., Huntington Beach, CA (US)

(21) Appl. No.: 14/210,847

(22) Filed: Mar. 14, 2014

Related U.S. Application Data
(60) Provisional application No. 61/790,893, filed on Mar. 15, 2013.

(51) Int. Cl. G01B 21/00; G01P 15/00

(52) U.S. Cl. CPC G01B 21/00; G01P 15/00
USPC 702/150

(57) ABSTRACT

Systems and methods are provided for visualizing motion by a sports participant. A system includes a motion detection module that comprises an accelerometer positioned on sports participant configured to measure one or more metrics associated with motion of the sports participant and a transmitter configured to wirelessly transmit the one or more metrics. A data processor is configured to access the one or more metrics and provide a visualization of the motion of the sports participant based on the one or more metrics.

### CROSS-REFERENCE TO RELATED APPLICATIONS

This application claims priority to U.S. Provisional Application No. 61/790,893, filed on Mar. 15, 2013, entitled “Capturing and Analyzing Board Sport Maneuver Data,” the entirety of which is herein incorporated by reference.

### FIELD

The field of the invention is garments and more particularly to sporting goods with embedded electronics.

### BACKGROUND

In recent years, garment manufacturers have sought to incorporate support for electronics into articles of clothing. Early products included pockets or housings to store items such as batteries. For example, U.S. Pat. No. 5,025,360, issued in 1991 describes a vest which is designed to house electrical batteries in pockets sewn into the vest. Later examples became more sophisticated, where proprietary connectors or electronic interfaces were incorporated into garments in order to connect specific electronic devices. The connectors were sewn into the garments alongside or within pockets that housed such devices. One well-known example of this technology is garments which incorporate connections for iPods in order to enable a wearer of such garment to store his iPod and listen to his music.

Certain more recent examples provide support for housing speakers and specific types of sensors in clothing. U.S. Pat. No. 6,772,442 discloses a golf glove having a pressure sensor that provides feedback to the golfer. A further example in U.S. Pat. No. 8,188,868 focuses on articles of clothing or items of equipment having the capability to sense physical and physiological characteristics associated with use of the clothing or equipment and to authorize interaction between the elements.

Despite the array of patents that incorporate electronics (e.g., sensors) into apparel and athletic equipment, such methods and systems have been incapable of accurately interpreting the data collected by the sensors to depict specific physical movements. Thus, there is a need for systems and methods which can more accurately interpret and depict data associated with movements.

### SUMMARY

A system uses cumulative data captured from sensors in apparel worn by, or in equipment used by, renowned board riding athletes. The cumulative data is used to derive baseline data equated to specific board riding maneuvers (hereafter, ideal maneuver data). The ideal maneuver data will have unique records with each unique record equating to a single board riding maneuver. In certain embodiments, ideal maneuver data can be compared with data captured from the movement of a specific board rider in order to accurately depict the movement.

In one embodiment, a system includes an item worn by a boardsport participant, including, for example: at least one sensor configured to sense an acceleration force of the boardsport participant, store data associated with the acceleration force, and transmit the data; a power source configured to provide power to the sensor; and an antenna configured to communicate the data to a distal device. The boardsport may be, for example, skateboarding, surfing, or snowboarding. The sensor may be, for example, an inertial measurement unit and/or a piezoelectric device. The data includes numbers that correspond to acceleration force over time in three-dimensional space. The distal device may be, for example, a mobile device or a camera.

In another embodiment, a system includes a board for engaging in a boardsport activity, the board including: at least one sensor configured to sense an acceleration force of the board, store data associated with the acceleration force, and transmit the data; a power source configured to provide power to the sensor; and an antenna configured to communicate the data to a distal device.

In yet another embodiment, a system for learning board riding skills includes: at least one sensor configured to detect a change in movement; a memory storing movement data associated with the changes in movement; and a transmitter transmitting the movement data to a remote receiver linked to a display screen that simultaneously displays the movement data graphically and numerically. The system may further include ideal maneuver data stored on the remote receiver, the ideal maneuver data including a plurality of records each identifying a type of board riding maneuver; a series of instructions designed to compare the movement data with the ideal maneuver data in order to determine a particular type of board riding maneuver associated with the movement data and to display the movement data as the particular type of board riding maneuver that was determined. In another embodiment, the system may further include an individualized animated avatar that graphically performs the particular type of board riding maneuver.

In yet another embodiment, a method includes the steps of: collecting professional board riding data associated with professional athletes; collecting amateur board riding data associated with an amateur board riding participant; and comparing the professional board riding data with the amateur board riding data in order to calculate a total variance between the amateur data and the professional data. The method may further include determining a rank of the amateur board riding participant.

In yet another embodiment, a computer-based method includes the steps of: detecting, using at least one sensor, maneuver data associated with a boardsport activity performed by a boardsport participant; providing, using a database, baseline data relevant for evaluating the detected maneuver data; analyzing, using a processor in communication with at least one sensor, the maneuver data based on the baseline data; and outputting, using a communications unit, output data based on the analyzed maneuver data.

In another example, a system for visualizing motion by a sports participant includes a motion detection module that comprises an accelerometer positioned on the sports participant configured to measure one or more metrics associated with motion of the sports participant and a transmitter configured to wirelessly transmit the one or more metrics. A data processor is configured to access the one or more metrics and provide a visualization of the motion of the sports participant based on the one or more metrics.

As a further example, a method of visualizing motion by a sports participant includes measuring one or more metrics associated with motion of a sports participant using an accelerometer. The one or more metrics are wirelessly transmitted. A data processor is used to access the one or more metrics and to provide a visualization of the motion of the sports participant based on the one or more metrics.

### BRIEF DESCRIPTION OF THE DRAWINGS

FIG. 1 is a block diagram of a computer-based system of capturing and analyzing maneuver data.

FIG. 2 illustrates a computer-based method/system of capturing maneuver data using first and second electromechanical devices, and analyzing and displaying the maneuver data using a processor of a portable electronic device.

FIG. 3 illustrates a computer-based method/system of capturing maneuver data using a first electromechanical device coupled to or integrated in a board, and analyzing and displaying the maneuver data using a processor of a portable electronic device.

FIG. 4 illustrates a computer-based method/system of capturing maneuver data using first and second electromechanical devices coupled to or integrated into footwear, and analyzing and displaying the maneuver data using a software application implemented in a portable electronic device.

FIG. 5 is a flowchart diagram for comparing, using a processor, amateur board riding data with ideal maneuver data.

FIG. 6 is a flowchart diagram for comparing, using a processor, maneuver data with ideal maneuver data collected from boardsport activities performed by professional athletes.

FIG. 7 illustrates a computer-based method/system of capturing maneuver data over a distance using a first electromechanical device and/or a second electromechanical device, and analyzing and displaying the sets of maneuver data using a portable electronic device positioned at a distance from the first and/or second electromechanical devices.

FIG. 8 illustrates a computer-based method/system of capturing maneuver data associated with a sports activity, and analyzing and displaying the maneuver data using software applications implemented in portable electronic devices.

FIGS. 9A, 9B, and 9C, in combination, illustrate a flowchart diagram of capturing maneuver data using first and second electromechanical devices coupled to or integrated in a board, footwear, or apparel, and analyzing and displaying the maneuver data using a mobile software application implemented in a portable electronic device.

FIGS. 10A and 10B illustrate a tracking view, a shoe closet view, a capture view, and a profile view, respectively, as displayed by a display of a portable electronic device operating a mobile application.

FIG. 11 illustrates a three-dimensional simulation display of analyzed maneuver data associated with a boardsport activity or trick.

FIGS. 12-17 depict a data processor generated visualization of the motion of a sports participant based on one or more metrics measured by a motion detection module.

FIG. 18 depicts a system for visualizing motion by a sports participant.

FIG. 19 is a flow diagram depicting a method of visualizing motion by a sports participant.

### DETAILED DESCRIPTION

FIG. 1 is a block diagram of a computer-based system of capturing and analyzing maneuver data. The system 100 includes a processor 102, a communications unit 104, sensors 106, a database 112, and an output device 114. Data stored in the database 112 may refer to data stored in a memory 108 (e.g., an on-board RAM or ROM memory) or on the network 110. The various units of the system 100 may communicate with one another utilizing a network 110. The sensors 106 include converters that measure a physical quantity associated with a sports activity and convert the measured physical quantity into a signal which can be analyzed or processed by the processor 102. For example, the sensors 106 can include accelerometers and gyroscopes that can provide measurements in one or more of an x-direction, a y-direction, a z-direction, roll, pitch, and yaw. A processor 102 is configured to analyze the detected data and draw an inference based on pre-programmed algorithms stored in the database 112, data stored in the database 112, previously or current learned data, or other data accessed via the network 110.

The detected data can include maneuver data associated with a boardsport activity or “trick.” A trick may refer to a boardsport activity performed requiring a certain level of skill that a user or a boardsport participant may be interested in learning, performing, or analyzing. Maneuver data includes any data detected regarding a movement of a sporting good, a movement of a garment, a movement of a sports participant or a body part of the sport participant, or any other data that may assist the processor 102 in drawing an inference regarding a boardsports activity or performed trick.

Referring to FIG. 2, the sensors 106 of the system 200 may be coupled to or integrated in a first electromechanical device 220. The sensors 106 include one or more sensors which can work in concert with one another. The first electromechanical device 220 may be integrated in or coupled to an item of clothing worn by a boardsport participant 210 (e.g., a shoe). In another embodiment, the first electromechanical device 220 may be integrated in or coupled to the board used by the boardsport participant 210, a sports article, an item carried by the user, or any item within proximity of the boardsport participant 210 (e.g., a snowboard or ski binding).

The sensors 106 are integrated in or coupled to the first electromechanical device 220 at sensor locations such as 240, 250, 260. In one example, the sensor locations 240, 250, 260 correspond with IC (Integrated Circuit) chips mounted on a PCB (Printed Circuit Board). The sensors 106 may be positioned at a distance away from the processor 102 and are in communication with the processor 102 via the network 110. For example, the processor 102 may be integrated in, connected to, or in communications with a distal device 280 (e.g., a portable electronic device), as shown in FIG. 2.

The sensors 106 may come in a variety of forms. For example, the sensors 106 may include positional encoders, compasses, navigational, and GPS sensors. The sensors 106 may include an inertial measurement unit (IMU), which detects velocity, orientation, and gravitational forces of the mobile unit, using a combination of accelerometers, compasses, distance sensors, geomagnetic sensors, and gyroscopes. The sensors 106 may further include various proximity/position sensors. In one example, the sensors 106 include one or more accelerometers or a G-sensor for measuring acceleration and tilt angles of body parts of the boardsport participant 210 or the board. The sensors 106 may also include one or more gyroscopes for measuring an angular rate of rotation of body parts of the boardsport participant 210 or the board. In another embodiment, the sensors 106 include magnetic sensors or e-compasses for detecting movement data with respect to the Earth's magnetic field. Further, the sensors 106 can also include pressure sensors configured to measure relative and absolute altitude. Additionally, the sensors 106 can include a piezoelectric device such as piezoelectric fibers configured to generate an electronic signal in response to mechanical stress.

A power source 270 (e.g., a battery) of the first electromechanical device 220 is configured to supply power to the sensors 106 and the transmitter/receiver 230. The transmitter/receiver 230 is configured to communicate the detected maneuver data to the distal device 280, or other devices via the network 110. The output of the transmitter/receiver 230 may include current loops, variable voltage levels, frequency or pulse signals, timers or counters, relays, and variable resistance outputs. The transmitter/receiver 230 can also provide radio frequency (RF) signals and transistor-transistor logic (TTL) outputs. For example, the sensors 106 in sensor locations 240, 250, or 260 may impose a current on the transmitter/receiver 230 proportional to the measurement of the detected maneuver data.

The processor 102 receives the detected maneuver data. The processor 102 is configured to analyze the detected maneuver data based on a pre-programmed algorithm or learned data stored in the processor 102 or database 112. The processor 102 is configured to draw an inference regarding the sports activity of the sports participant. That processing may be aided by off-board cloud-based computing available via the network 110. The processor 102 is coupled to a communications unit 104 or an output device 114 for outputting the analyzed maneuver data. For example, the communications unit 104 may be a display of the distal device 28, such as a portable electronic device or a smartphone. The boardsport participant 210 may in real time or at a later time review analyzed data regarding the detected and analyzed boardsport activity.

The processor 102 can be configured to output helpful output data to the boardsport participant 210 regarding the boardsport activity to help the boardsport participant 210 with learning or improving execution of a trick. Such output data can be based on a pre-programmed algorithm or previously stored data retrieved from the database 112. In one embodiment, the previously stored data or algorithm in the database 112 may correspond to ideal maneuver data associated with a professional athlete performing similar sports activities. For example, the ideal maneuver data can be captured based on at least one professional board rider performing similar board activities. The processor 102 stores the ideal maneuver data in the database 112 to serve as benchmarks for drawing inferences regarding the detected and analyzed maneuver data of a later user. The processor 102 directs the communications unit 104 or an output device 114 to generate helpful output data based on a drawn comparison between the analyzed maneuver data of the user and the ideal maneuver data.

FIG. 3 depicts a system where first electromechanical device 320 is coupled to or integrated within a board 310 in lieu of or in addition to an electromechanical device associated with a clothing article. As such, the user maneuver data is detected with respect to movement of the board 310 in addition to any other data associated with motion of the boardsport participant that is captured. This additional data associated with the board further enables inferences to be drawn regarding the sports activity or trick performed. The processor 102 directs the communications unit 104 (e.g., display and/or speaker) of the distal device 380 to output helpful output data associated with the analyzed sports activity or trick.

FIG. 4 illustrates a computer-based method/system of capturing maneuver data using first and second electromechanical devices and analyzing and displaying the maneuver data using a software application implemented in a portable electronic device. An electromechanical device is coupled to or integrated in a garment or article of apparel of a boardsport participant (e.g., shoes). A combination of one or more of the sensors 106 described above is utilized in the first electromechanical device 410 (e.g., in the sensor location 420). In one example, an IMU is incorporated in sensor location 420. The IMU in sensor location 420 outputs maneuver data regarding x-direction linear acceleration, y-direction linear acceleration, z-direction linear acceleration, roll, pitch, and yaw acceleration, x, y, and z direction gravitational pulls.

The transmitter/receiver 430 is configured to generate a wireless signal 435 based on the detected maneuver data. In one embodiment, a distal device such as a portable electronic device receives and analyzes the detected maneuver data by analyzing the transmitted wireless signal 435. In the example of FIG. 4, a smartphone is utilized as a distal device receiving the transmitted signal via a distal transmitter/receiver 440 integrated in the smartphone. The processor 102 is configured to analyze the detected maneuver data based on previously stored data (e.g., data captured from sports activities performed by professional athletes or other data regarding sports activities retrieved from the Internet 495 or the database 112), a pre-programmed data or algorithm, learned data from previous detection and processing, or combinations thereof. When the sports participant seeks to analyze a performed boardsport trick, the processor 102 generates output data corresponding to the performed boardsport trick using the communications unit 104 (e.g., a display and/or a speaker of a smartphone, tablet, a laptop, or various other portable electronic devices).

For example, the processor 102 may provide a simulated visualization of the captured trick in 3-D (three-dimensional) space. In such an example, the detected maneuver data is transposed to Cartesian coordinates in order for the performed trick to be displayed in reference to the x-axis 455, the y-axis 480, and the z-axis 445. In one particular example, the analyzed boardsport trick is a “kickflip.” During a kickflip, the boardsport participant's goal is to Ollie and kick his foot out and flip the board 360 degrees along the x-axis 455 with his feet, thereby allowing the board to spin all the way around before the boardsport board participant catches the board and lands safely in time. The boardsport participant seeks to perform the Ollie trick via a maneuver in which the boardsport participant kicks the tail of the board down while jumping in order to make the board pop into the air.

In producing a visualization of the captured kickflip trick, the processor 102 analyzes and directs the communications unit 104 to display the first movement 450 corresponding to captured maneuver data associated with a movement of the first foot of the boardsport participant. The processor 102 further analyzes and directs the communications unit 104 to display the second movement 475 corresponding to maneuver data associated with a movement of the second foot of the boardsport participant. The processor 102 thus directs the depiction of the paths traversed by each of the feet of the boardsport participant in attempting the kickflip trick.

The processor 102 may further direct display of certain bibliographic data associated with the location, date, and time 460 of the detected and analyzed trick. The location may be determined, for example, using a GPS device integrated in the smartphone or received by the processor 102, which enables the stored maneuver data regarding the trick to be geo-tagged with location metadata. A camera of the smartphone can also be directed to capture an image of the location of the trick when the trick is performed or a video of the trick as it is being performed, where such captured image data is associated with the particular trick attempt. All such captured data can be stored in the database 112.

The processor 102 may further direct the communications unit 104 to display the boardsport trick type 485 (e.g., the kickflip) in order to inform the boardsport participant or another person viewing the data about the type of the trick performed. The type of trick performed may be automatically detected or may be selected by user input. The processor 102 may further direct the communications unit 104 to display certain metrics associated with the captured trick such as heights 465 (e.g., in inches) reached during the kickflip, detected speeds 470 (e.g., in miles per hour units) reached during the kickflip, and certain accelerations measured by an accelerometer during the trick (e.g., in a gravitational force or g-force unit).

While FIG. 4 displays analyzing and displaying trick data using a mobile device of a boardsport participant, the analyzed data may be outputted to other networks or devices beyond the distal device of the boardsport participant. For example, boardsport participants may share analyzed data of tricks performed with an outside entity, and the sharing boardsport participants can be ranked accordingly based on their analyzed performances.

FIG. 5 is a flow diagram depicting steps of a process for analyzing detected maneuver data with respect to ideal maneuver data generated through observation of a professional. In step 510, professional boarding data associated with professional athletes is collected. In one embodiment, the collected professional boarding data corresponds to a set of data characterizing a boardsport activity performed by at least one professional athlete. The professional boarding data is catalogued and analyzed based on various instances of detection and processing. In one embodiment, the professional boarding data associated with multiple professional athletes is averaged. Various statistical analysis (such as eliminating outlier data) may be employed to generate ideal maneuver data such that the ideal maneuver data provides benchmarks or criteria for the processor 102 to analyze the detected maneuver data of a boardsport participant. At 520, maneuver data is detected and analyzed regarding a boardsport activity performed by a boardsport participant. At 530, the processor 102 compares the detected and analyzed maneuver data of the boardsport participant (e.g., based on the collected amateur boarding collected in step 520) with the ideal maneuver data (e.g., the professional data collected in step 510). For example, in step 530 the processor 102 may calculate a total variance between the maneuver data associated with the amateur boardsport participant with the ideal maneuver data (e.g., the professional data). The processor 102 further directs the communications unit 104 to generate output data conveying information regarding the calculated total variance. Various other statistical comparisons between the detected and analyzed maneuver data of the boardsport participant and the ideal maneuver data may be drawn in order to generate output data helpful for assisting the boardsport participant in evaluating and improving his performance in conducting the boardsport activity or trick.

FIG. 6 discloses a process of collecting and utilizing professional boarding data associated with professional athletes (e.g., the professional board riders 605). In step 615, ideal maneuver data 620 is compiled based on analysis of professional boarding data associated with professional athletes (e.g., professional board riders 605). Various statistical analysis, such as eliminating outlier data, are employed to generate professional boarding data that provides benchmarks for the processor 102 to analyze the detected maneuver data of a boardsport participant. Three professional board riders 605 are shown for illustration purposes. In another embodiment, the ideal maneuver data may not be detected and analyzed maneuvering of professional board riders, but is instead estimated or obtained from another source based on data previously stored or estimated by another system. A second ideal maneuver data set 630, a third ideal maneuver data set 635, and other ideal maneuver data sets may be compiled using the detected and analyzed ideal maneuver data 620. For example, the data sets may be categorized based on the trick or boardsport activity performed.

FIG. 6 shows that the ideal maneuver data 620 may include, for example, data regarding various boardsport activities, performances, and tricks. For example, a first ideal maneuver data set 625 may correspond to data quantifying a kickflip using acceleration, speed, reached height, and other data with respect to analysis of maneuver data detected by the sensors 106. The data listed in the first ideal maneuver data set 625 (e.g., “0.5, 1, 0, 4.2, 2”) may correspond to measures of the detected maneuver data. For example, one of the numbers may rank height reached using a quantifiable unit. The second ideal maneuver data set 630 and a third ideal maneuver data set 635 may be compiled based on ideal maneuver data corresponding, for example, to an Ollie trick and a Shove-it trick performed by the three professional board riders 605.

Maneuver data with respect to a boardsport activity or trick performed by an amateur board rider 610 is captured, as shown at 640. At 640, that maneuver data 645 is compiled. A first maneuver data set 650 corresponds to a kickflip trick performed by an amateur board rider 610. At 665, the processor 102 compares the first maneuver data set 650 corresponding to a kickflip performed by the amateur board rider 610 with the first ideal maneuver data set 625 corresponding to kickflip data compiled based on performances of the three professional board riders 605. The processor 102 generates output data based on the comparisons for the selected kickflip trick at 670. In one embodiment, a graph or image is displayed, juxtaposing both the ideal maneuver data 620 and the boardsport participant maneuver data 645 to assist in evaluating the amateur board rider's 610 trick performance.

For example, the processor 102 may direct a display of an output comparison data set 675 that includes analyzed ideal maneuver data 680 for the selected kickflip trick 670 as performed by the professional board riders 605 compared with analyzed amateur board rider kickflip data 685 associated with the selected kickflip trick as performed by the amateur board rider 610. In addition, visualizations of both the ideal maneuver data 620 body/board positioning versus the participant's maneuver data 645 body/board positioning in three dimensional space can be provided simultaneously or in series to provide a comparison for viewing.

In one embodiment, the processor 102 is configured to generate recommendation output data to assist the amateur board rider 610 in improving or learning the compared trick or boardsport activity. For example, the processor 102 may recommend a change in the second movement 475 corresponding to the second foot of the amateur board rider 610 to better performance of the trick.

FIG. 7 displays a system 700 by which competition judges 724 can analyze maneuver data of a boardsport participant 710 via portable electronic devices 780. The sensors 106 are positioned in at least one of locations 720. For example, the sensors 106 may be positioned on the feet of the first boardsport participant 710, the clothing of the boardsport participant 710, and/or the surfboard 712. A jet ski includes transmitters/receivers 722 that can serve as a relay between the boardsport participant 710 and the judges' table. The surfboard 712 is equipped with a first transmitter/receiver configured to communicate with the second transmitters/receivers 718 and 722 on the jet ski or directly with the third transmitters/receivers of the judges' portable electronic devices 780. In another embodiment, the sensors 106 can communicate directly to the judges' portable electronic devices.

The trick data captured and relayed to the judges may be provided to the judges in a relatively raw form (e.g., height, speed). In another embodiment, maneuver data of the boardsport participant 710 is further analyzed, such as based on ideal maneuver data stored in the database 112, before being provided to the judges as a scoring aid. In other embodiments, the boardsport participant's entire score is based on the maneuver data processed by a scoring algorithm.

The analyzed maneuver data can be utilized in a variety of additional ways as well. For example, analyzed maneuver data across a number of users can be utilized as a mechanism for scouting talent. Analyzed maneuver data associated with human actions is captured, associated with the user who performed the captured actions, and stored in a database. The maneuver data can be computer sorted, filtered, and otherwise processed to identify candidate users who meet certain criteria. For example, a search may be performed to identify a top 10% of users (e.g., top 10% of performers of a certain trick, top 10% of users based on average performance of all tricks weighted by difficulty). Identified users can be contacted and provided offers, such as offers for tryouts, offers to attend camps or clinics, and offers for sponsorships.

In another embodiment, analyzed maneuver data can be utilized in generating a digital avatar that resembles a user's looks and/or ability levels. Facial and other body characteristics can be manually entered or can be digitally estimated based on image or other biometric input. User statistics, such as ability level statistics, can be attributed to the user based on analyzed maneuver data. For example, an avatar's speed and agility can be set based on speed and agility of the user in performing certain activities represented by analyzed maneuver data. In one example, a user avatar is able to perform a trick, such as a kickflip, when the user has been able to capture successful performance of the trick and associated maneuver data. The user avatar can continually be updated based on uploading of additional maneuver data.

FIG. 8 depicts a system modified to analyze maneuver data for sports activities other than boardsports. In FIG. 8, the sport participant 810 is shown playing basketball. First electromechanical devices 820 may be positioned on body parts of the sport participant 810, a garment, a clothing article, or combinations thereof for detecting maneuver data associated with the sports activity performed. One or more of the first electromechanical devices 820 may include a power source 870, a transmitter/receiver 830, and sensors 106 at sensor locations 840, 850, and 860. In one embodiment, the first electromechanical devices 820 are coupled to or in communications with one another in a manner that require less circuitry in order to reduce power consumption or transmission/receiving ranges. In one example, the first electromechanical devices 820 are in communications with a first distal device 880 used by the sport participant 810 and a second distal device 882. The first distal device 880 and/or the second distal device 882 may communicate with the network to upload or share analyzed maneuver data and retrieve previously stored data.

FIGS. 9A and 9B illustrate a flowchart diagram of capturing maneuver data using a first electromechanical device, and analyzing and displaying the maneuver data using a mobile software application implemented in a portable electronic device. At 902, a user opens and runs the software application. If the user is not logged in, as shown in step 924, the user logs in using the user name and password in step 908. If the user has not previously registered, the user may select the new user option in step 922 which prompts the user to submit his name, age, height, weight, stance, email, desired user name, desired password, other profile information, as well as other information that may be helpful in evaluating the maneuver data. The log-in process may not be necessary if the user has already logged in before opening the application, as shown in step 926. In one embodiment, the mobile application is in communications with a social network database (e.g., the Facebook™ or the Twitter™) in order to allow the user to log in using the account associated with the social network database.

When a user logs in, the processor 102 automatically or upon user request activates the sensors 106 as shown in step 910. After the sensors 106 are activated, the processor 102 transmits a signal to a first electromechanical device or the sensors 106 to initiate transmitting and receiving maneuver data as shown in step 912. In one example, an LED is provided on the shoes, the first electromechanical device, or other devices or articles of apparel, as shown in steps 914 and 928, to indicate to the user that connection is established and that the sensors 106 are ready for detecting and communicating maneuver data.

As shown in step 916, the processor 102 directs a display of the smart phone to display helpful information that may assist the user in troubleshooting any issues with establishing communication between the sensors 106 and the processor 102. For example, the processor 102 can output frequently asked questions regarding establishing connection, tutorials for the user to configure the mobile application and/or the sensors 106 to establish successful communications, contact information for a customer service center, a link to an external website containing helpful information, other data that may assist the user in configuring the system 900 to establish communications. When the processor 102 determines that the communication is established with the sensors 106 as shown in step 918, the processor 102 proceeds to step 920. A view my profile link can be accessed via 910 before proceeding to 920.

At 920, the user is provided with at least four options of live force measurement mode 903, learn tricks mode 905, completed tricks mode 907, or ideal maneuver data mode 909. In the live force measurement mode 903, when “Record” is selected in step 938, detected maneuver data is detected, shared, compared, saved (e.g., stored in the database 112), or redone (e.g., re-performing the analyzed trick) as described above with respect to FIGS. 1-7. The stored data is geo-tagged in step 980. “My Tricks” herein refers to a set of analyzed maneuver data stored in the database 112 associated with at least one trick performed by the boardsport participant or the user, for example, as stored or shared in step 982. When the user selects in step 952 to share My Tricks, other analyzed maneuver data, geo-tagged data, or other meta-data associated with any performed tricks, the processor 102 shares the selected data using the social network, as shown in step 954. In step 978, the processor 102 activates the corresponding dedicated application for the selected social network to share the information according to the user's request or automatically as operated by the processor 102. Furthermore, in step 952, when the user selects to save (as shown in step 952), the display may prompt the user to select to geo-tag, add notes, add media, or add other data associated with the performed trick for later review or for sharing as shown in step 965. In other embodiments, geo-tagging is performed automatically using data received from, for example, a GPS device.

When the learn tricks mode 905 is selected, the user selects a particular trick that the user desires to learn as shown in step 932. At 938, the user chooses the “how to” option which leads the processor 102 to display a media recorded in the database 112 regarding instructions on how to perform the trick as shown in step 950. After viewing the tutorial media as shown in step 976, the user selects “Try Yourself” as shown in step 950. The processor 102 then operates under step 952 and detects and analyzes maneuver data as described above.

When the user selects “More Tricks” as shown in step 932, additional tricks may be retrieved from the database 112. In one embodiment, the additional tricks are in-app purchases that will require the user to make a payment via a software application in order to have access to the additional trick, as shown in steps 956 and 970. For example, the purchase may grant access to additional tutorial videos regarding the additional tricks. In another embodiment, the purchase further grants access to additional analysis algorithms regarding the purchased tricks. In a further embodiment, the purchase further grants access to additional ideal maneuver data which may assist the user and the processor 102 in evaluating the user's performance of the additional tricks.

When completed tricks mode 907 is selected, the previously stored “My Tricks” discussed above are listed as shown in step 934. For example, if the Ollie trick is selected, a list of instances of previously performed tricks is displayed as shown in step 940. Once a particular instance of performing the Ollie trick is selected, the analyzed maneuver data in comparison to the ideal maneuver data is displayed as shown in step 948. In one embodiment, the comparison graph shown in step 948 is juxtaposed next to a photo of the corresponding Ollie performance. Geo-tagged data and other meta-data associated with the chosen trick of the “My Tricks” are further displayed. In step 958, comparisons of sets of maneuver data (performed for example, at various instances) with the ideal maneuver data are displayed on the same display screen image. As shown in steps 960, 962, 964, and 968, the user can assign images or video to a particular set of stored “My Tricks” using a camera of the portable electronic device, previewing, and selecting an image, retrieving an image from the photo library or the database 112, or assigning other media data associated with the “My Tricks.”

In the ideal maneuver data mode 909, the user may select a particular trick to learn more about, for example, skills and techniques required to perform the trick, compare ideal maneuver data of professional board riders versus one another, review average ideal maneuver data of professional board riders, evaluate goals as to various parameters quantifying a well-performed trick, or other inferences drawn based on the ideal maneuver data. In step 942, when the user selects “By Average,” average ideal maneuver data for more than one professional board riders is displayed in step 974. Furthermore, the average ideal maneuver data can be compared with the “My Tricks” previously stored in the database 112.

When “By Skater” is selected in step 942, information about ideal maneuver data of a professional board rider for performing the selected trick is displayed. Furthermore, the ideal maneuver data of the selected professional board rider can be compared with other professional board riders and with maneuver data of the user as stored, for example, in the “My Tricks,” as shown in step 972. Thereafter, step 958 as described above may be performed. Moreover, the user may be provided with an in-app link or a link to a website to purchase garments, clothing articles, and other products associated with boardsports.

FIG. 10 illustrates a tracking view, a shoe closet view, a capture view, and a profile view, respectively, as displayed by a display of a portable electronic device operating a mobile application. The user or the boardsport participant can select the home mode 1020, the profile mode 1022, the track mode 1040, or the activity mode 1038.

When the tracking view mode 1002 is active or selected, the processor 102 displays the current track status 1024. A 3-D image/video 1032 can be displayed based on analysis of kickflip performed by the user. The 3-D image/video 1032 may be controlled by the user using the touch-screen display and the scroll 1034. The 3-D image/video 1032 displays the first movement 1012 corresponding to maneuver data associated with a movement of the first foot of the boardsport participant or the user. The processor 102 analyzes and directs the communications unit 104 to display the second movement 1010 corresponding to maneuver data associated with a movement of the second foot of the boardsport participant or the user to provide a visualization of the performed trick.

Portions of the first movement 1012 or the second movement 1010 may be color coded based on the color code 1008 to display the particular speed associated with corresponding portions of the first movement 1012 or the second movement 1010. For example, the color code 1008 may indicate that the portions shown in yellow are associated with a fast movement and the portions shown with blue are associated with relatively slower movements. Mixtures of colors in between yellow and blue are displayed to show movements between both ends of the speed spectrum. The simulated shoes 1014 are displayed to inform the user regarding the shoe that the user was wearing during the trick performance and to allow the user to better evaluate the first movement 1012 and the second movement 1010. The kickflip 1030 title is displayed to inform the user that the analyzed maneuver data being displayed is associated with a kickflip trick. The date, location, and time 1028 of the performance of the trick are further be displayed. The height 1016, the speed 1018, and the acceleration force 1036 are also displayed. The “REDO” option 1004 activates detection and analysis of data for re-performing the selected kickflip 1030 trick.

As shown in the shoe closet view mode 1060, the user can view the simulated shoes 1068 that were previously detected (e.g., via the sensors 106), added via inputs received from the user, added using other data retrieved from the network 110, or otherwise. Using the add button 1026, the user is allowed to input further data to supplement the data stored in the database 112. The add shoe button 1070 enables the user to add additional shoes to the shoe closet 1064.

The shoe closet additionally enables tracking of wear cycles of shoes and other data associated with tricks performed in particular pairs of shoes. For example, the shoe closet can identify metrics such as total distance travelled in the pair of shoes and a number of maneuvers attempted or performed in the particular pair of shoes. Additionally, maneuver data can be further drilled down to identify particular tricks performed, dates, times, and places associated with tricks performed, as well as analyzed maneuver data associated with individual tricks.

As shown in the profile view mode 1078, the profile status 1091 is displayed as the current mode. In the profile view mode 1078, the user can review previously stored data regarding the user and the user's activities including but not limited to previously stored maneuver data. The shoe closet option 1098 activates the shoe closet view mode 1060 to be displayed. An image 1080 of the user during a trick may be tagged to the stored trick using meta-data and displayed when the trick is selected. The user can further review previously stored images and videos by choosing the photos/views selection 1082. The user can further choose, using the touch-screen display, the tricks 1084 (e.g., previously performed tricks or activities), the to-do list 1086 (e.g., tricks indicated by the user or the software application to be performed in future), favorite spots 1099 (e.g., indicating favorite locations suitable for performing the tricks as selected by the user or as determined by the processor 102 based on user preferences and based on maneuver data and/or ideal maneuver data) and statistics 1096 (e.g., for reviewing statistical data regarding previously performed tricks or boardsports activities). The rank 1094 of the user may further be displayed. For example, the rank 1094 may be “1st/professional” when the processor 102 determines that, as compared to the ideal maneuver data (or as compared to maneuver data detected from other users or boardsports participants sharing data using the network 110), the maneuver data of the user indicates a high level of skill. As such, the user may be encouraged to use the mobile software application to record tricks to improve skills and associated rank 1094. A list of the recent activity 1088 may further be displayed summarizing date, time, location, level of skill, analyzed maneuver data, or other data associated with one or more recently performed tricks or boardsport activities.

In the capture view mode 1042, a video 1048 of a boardsport trick or activity can be recorded. In one embodiment, previously stored digital signal processing algorithms are utilized for enabling the processor 102 to examine the maneuver data based at least in part on the video 1048. In one example, the acceleration force 1054, the height 1056 reached, the speed 1058, or other analyzed maneuver data are displayed. In another embodiment, the acceleration force 1054, the height 1056 reached, the speed 1058, or other analyzed maneuver data are supplemented by data detected by the sensors 106.

FIG. 11 illustrates a three-dimensional simulation display of analyzed maneuver data associated with a boardsport activity or trick. For example, the three-dimensional simulation display of analyzed maneuver data shown in FIG. 11 may correspond to the 3-D image/video 1032 discussed above with respect to FIG. 10. For example, the 3-D image/video 1102 may illustrate the simulated shoes 1104 and the simulated board 1106. In other embodiments, other videos or images associated with the detected and analyzed maneuver data (e.g., simulated body parts of the board participant) may be displayed. For example, an avatar of the board participant may be graphically displayed in order to illustrate the performed trick based on the analyzed maneuver data.

FIGS. 12-17 depict a data processor generated visualization of the motion of a sports participant based on one or more metrics measured by a motion detection module. FIG. 12 depicts a first frame of a visualization that runs from a start 1202 of a captured trick to a finish 1204 of that captured trick from a first vantage point. A motion detection module was attached to the left foot of the sports participant (skateboarder). Thus, the visualization tracks motion of the left foot via a plot line 1206. The plot line 1206 is colored based on a speed of the motion detection module at points along the path traversed by the left foot of the skateboarder. In the frame depicted in FIG. 12, the entirety of the plot line 1206 is colored orange, which according the key 1208 indicates fast speed. The visualization further depicts certain metric data, such as the height 1210 of the motion detection module in the depicted frame, the speed 1212 at the time depicted, and the force experienced 1214. The visualization further includes the name of the trick being depicted at 1216. In one embodiment, the name of the trick being performed is automatically detected based on the one or more metrics received from the motion detection module. In another embodiment, the name of the trick is identified by user input. The visualization further includes depiction of bibliographic data 1218 associated with the captured trick, including location, date, and time of the recording. In one embodiment, each of the bibliographic data items 1218 are captured automatically by a mobile device that receives transmitted metrics from a motion detection module in real-time.

FIG. 13 depicts a second frame of the visualization from the first vantage point. The plot line is advanced as the trick has continued, with the depicted two feet and skateboard being depicted based on the one or more metrics received from the motion detection module. While certain points 1302 on the plot line are orange, indicating a fast speed at the point depicted, other points 1304 on the plot line are blue indicating a slower speed of the motion detection module at those points. FIG. 14 shows a frame of the visualization from a second vantage point, early in the trick, while FIG. 15 shows a later frame of the visualization from the second vantage point, near the end of the trick. FIG. 16 depicts the visualization from a third, overhead vantage point, while FIG. 17 depicts a position of the skateboarder's feet, skateboard, and a plot line at a later point in the trick from the third vantage point.

FIG. 18 depicts a system for visualizing motion by a sports participant. The system includes a motion detection module 1802 worn on a body part 1804 of a sports participant. The motion detection module 1802 includes an accelerometer 1806 configured to measure one or more metrics associated with motion of the sports participant. The motion detection module 1802 further includes a transmitter 1808 configured to wirelessly transmit the one or more metrics. The system further includes a data processor 1810, such as a data processor 1810 of a mobile device 1812, such as a smart phone or tablet device. The data processor 1810 is configured to access the one or more metrics from the motion detection module, such as from a data store 1814 that stores the metric data when it is wirelessly received from the motion detection module. The data processor 1810 is further configured to provide a visualization of the motion of the sports participant based on the one or more metrics, such as on a display 1816 of the mobile device 1812.

FIG. 19 is a flow diagram depicting a method of visualizing motion by a sports participant. At 1902, the method of visualizing motion by a sports participant includes measuring one or more metrics associated with motion of a sports participant using an accelerometer. The one or more metrics are wirelessly transmitted at 1904. At 1906, a data processor is used to access the one or more metrics and to provide a visualization of the motion of the sports participant based on the one or more metrics.

This application uses examples to illustrate the invention. The patentable scope of the invention includes other examples.

What is claimed is:

1. A system for visualizing motion by a sports participant, comprising:
a motion detection module, comprising:
an accelerometer positioned on sports participant, the accelerometer configured to measure one or more metrics associated with motion of the sports participant;
a transmitter configured to wirelessly transmit the one or more metrics;
a data processor on a mobile device configured to access the one or more metrics and provide a visualization of the motion of the sports participant based on the one or more metrics.

2. The system of claim 1, wherein the data processor is configured to determine a position of a body part of the sports participant at a particular time in a three dimensional volume based on the one or more metrics.

3. The system of claim 2, wherein the data processor is configured to generate an animation of positions of the body part of the sports participant over a period of time, wherein the animation includes depiction of the position of the body part at the particular time.

4. The system of claim 3, wherein the animation further displays physics data associated with the body part.

5. The system of claim 4, wherein the physics data includes a height of the body part, a speed of the body part, orientation and a force experienced by the body part.

6. The system of claim 2, wherein the accelerometer is fastened to an article of clothing near the body part of the sports participant.

7. The system of claim 2, wherein the accelerometer is configured to track roll, pitch, and yaw of the body part.

8. The system of claim 2, wherein the body part is a foot of the sports participant, wherein the sports participant is participating in a sport that utilizes a board.

9. The system of claim 8, further comprising a second motion detection module, wherein the second motion detection module is attached to the board.

10. The system of claim 9, wherein the visualization depicts the body part and the board.

11. The system of claim 2, further comprising a second motion detection module attached to a different body part of the sports participant.

12. The system of claim 1, wherein the data processor is configured to determine a type of maneuver based on the one or more metrics, wherein the type of maneuver is displayed on the visualization.

13. The system of claim 1, wherein the data processor is further configured to provide a visualization of a body part successfully completing a user selected maneuver.

14. The system of claim 1, further comprising a computer-readable medium configured to store ideal maneuver data;
wherein the data processor is configured to compare the one or more metrics with the ideal maneuver data to provide a score for the sports participant.

15. The system of claim 14, wherein the ideal maneuver data is based on a performance of a maneuver by an expert wearing a motion detection module.

16. The system of claim 15, wherein the score is based on an average distance of the one or more metrics associated with the sports participant with metrics based on the expert performance of the maneuver.

17. The system of claim 15, wherein the score is based on a difference of speed, height, or force associated with the sports participant performance of the maneuver and the expert performance of the maneuver.

18. The system of claim 1, wherein the data processor is configured to provide a competition score that is based at least in part on the one or more metrics.

19. The system of claim 1, wherein the visualization provides a two dimensional line that identifies a position of the motion detection module over time.

20. The system of claim 19, wherein the line is colored based on a speed of the motion detection module at each position depicted.

21. The system of claim 1, wherein the one or more metrics are utilized in generating a digital avatar of the sports participant.

22. The system of claim 1, further comprising a database for storing metric data associated with a plurality of sports participants, wherein one or more data processors are configured to sort or filter the metric data stored in the database to identify top performers.

23. The system of claim 22, wherein an offer is provided to the identified top performers.

24. The system of claim 1, further comprising a database for storing metric data associated with a plurality of sports participants, wherein certain of the plurality of sports participants are professional sports participants;
wherein the data processor is configured to command display of a comparison of the one or more metrics of the sports participant with the metric data associated with other sports participants to provide a relative comparison and ranking of the sports participant with respect to the other sports participants, including the professional sports participants.

25. A method of visualizing motion by a sports participant, comprising:
measuring one or more metrics associated with motion of a sports participant using an accelerometer;
wirelessly transmitting the one or more metrics;
using a data processor to access the one or more metrics and to provide a visualization of the motion of the sports participant based on the one or more metrics.

26. A system for visualizing motion by a boardsport participant, comprising:
a motion detection module permanently embedded in a board of a boardsport participant, comprising:
an accelerometer embedded in the board of a boardsport participant, the accelerometer configured to measure one or more metrics associated with motion of the sports participant;
a transmitter configured to wirelessly transmit the one or more metrics;
a data processor on a mobile device configured to access the one or more metrics and provide a visualization of the motion of the board of the boardsport participant based on the one or more metrics.
